(19) United States
(12) Patent Application Publication
(10) Pub. No.: US 2006/0106819 A1
(43) Pub. Date: May 18, 2006

(54) Method and apparatus for managing a computer data storage system

(76) Inventors: Komateswar Dhanadevan, Bangalore (IN); Satish Kumar Mopur, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/977,191

(22) Filed: Oct. 28, 2004

(51) Int. Cl. G06F 7/00

(52) U.S. Cl. 707/100

(57) ABSTRACT

A method and apparatus is disclosed for managing a Storage Area Network (SAN) in which testing of a SAN configuration and selection of suitable test cases is carried out automatically. The system is also able to search a SAN configuration to determine the particular element or region of a SAN responsible for a detected fault.

### FIELD OF INVENTION

The present invention relates to a method and apparatus for managing a computer data storage system. More particularly, but not exclusively, the present invention relates to a management system for a network of storage devices, which facilitates the testing of the network.

### BACKGROUND OF THE INVENTION

A Storage Area Network (SAN) is a high-speed network of shared computer data storage devices. Each storage device comprises a disk or disks for storing data. The architecture of a SAN is designed to make all storage devices available to all server computers on a network. The hardware that connects all server computers to all of the storage devices in the SAN is referred to as the SAN Fabric. The SAN Fabric is commonly implemented using fibre channel switching technology. Since the data stored in a SAN does not reside directly on any of the server computers that access the data, computer power is saved for application programs and network capacity that would otherwise be used for data access is released since data access is provided though the SAN Fabric.

A SAN is a complex system which requires careful design, management and maintenance. There is a wide choice of hardware and software for building a SAN which can be configured and interconnected in a large number of ways. Tools exist which provide management systems for SANs. For example, the ControlCenter™ family of storage resource and device management system produced by the EMC²™ Corporation, supports monitoring, planning, provisioning and reporting for storage devices/networks. Another example is the Tivoli™ SAN manager produced by the IBM™ Corporation, which supports features such as SAN discovery, design validation, provisioning and device failure notifications.

SAN configurations commonly consist of groups of systems with different platforms or operating systems and components from different manufacturers. This contributes to one of the problems which arise when building, maintaining or modifying a SAN which is how to adequately test the new configuration and components to determine if it is effective, robust and reliable. Creating suitable testing regimes for a large number of possible SAN configurations and components is difficult. Furthermore, if faults exist, identifying the problem area is a complex task.

It is an object of the present invention to provide a method and apparatus for managing a computer data storage system, which avoids some of the above disadvantages or at least provides the public with a useful choice.

### SUMMARY OF THE INVENTION

According to a first aspect of the invention there is provided a method of managing a data storage network, the method comprising the steps of:

a) storing a model configuration of a data storage network and an associated test scenario for the model data storage network;

b) collecting data representing an actual data storage network configuration;

c) comparing the data representing the actual data storage network to the model configuration of a data storage network; and

d) if the collected data corresponds to the stored model configuration then applying the associated test scenario to the actual data storage network.

Preferably the data storage network is a Storage Area Network (SAN). Preferably in step d) if the collected data only partially corresponds to the model configuration then only applying the elements of the test scenario to the actual data storage network where the partial correspondence exists. Preferably the method further comprises the step of: e) storing a model of the actual data storage network and subsequently comparing data representing a further actual data storage network and the stored models and selecting one of the models which corresponds most closely to the further actual data storage network. Preferably the model comprises topological data and component characteristics. Preferably in step a) a set of fault finding procedures are stored and if a fault indicated by the test scenario corresponds to one of the fault finding procedures, the procedure is applied to the actual data storage network to locate the fault. Preferably the fault finding procedures are arranged to locate a fault within a region of the actual data storage network. Preferably the fault finding procedures are arranged to locate a fault within an element of the actual data storage network.

According to a second aspect of the invention there is provided apparatus for managing a data storage network comprising:

a database for storing a model configuration of a data storage network and an associated test scenario for the model data storage network;

an engine for collecting data representing an actual data storage network configuration; and

an expert system for comparing the data representing the actual data storage network to the model configuration of a data storage network, wherein if the collected data corresponds to the stored model configuration then the engine is further operable to apply the associated test scenario to the actual data storage network.

According to a third aspect of the invention there is provided a computer program or group of computer programs arranged to enable a computer or group of computer programs to carry out a method of managing a data storage network, the method comprising the steps of:

a) storing a model configuration of a data storage network and an associated test scenario for the model data storage network;

b) collecting data representing an actual data storage network configuration;

c) comparing the data representing the actual data storage network to the model configuration of a data storage network; and

d) if the collected data corresponds to the stored model configuration then applying the associated test scenario to the actual data storage network.

According to a fourth aspect of the invention there is provided a computer program or group of computer programs arranged to enable a computer or group of computer programs to provide apparatus for managing a data storage network comprising:

a database for storing a model configuration of a data storage network and an associated test scenario for the model data storage network;

an engine for collecting data representing an actual data storage network configuration; and

an expert system for comparing the data representing the actual data storage network to the model configuration of a data storage network, wherein if the collected data corresponds to the stored model configuration then the engine is further operable to apply the associated test scenario to the actual data storage network

According to a fifth aspect of the invention there is provided apparatus for automated selection of test scenarios for a Storage Area Network (SAN), the apparatus comprising:

an expert system database for storing a model configuration of a SAN and an associated test scenario for the SAN;

a SAN engine for collecting data representing an actual SAN configuration;

an expert system for comparing the data representing the actual SAN to the model configuration of a SAN; and

a scenario interpreter operable, if the collected data corresponds to the stored model configuration, to apply the associated test scenario to the actual SAN.

### BRIEF DESCRIPTION OF THE DRAWINGS

Embodiments of the invention will now be described, by way of example only, with reference to the accompanying drawings in which:

FIG. 1 is a schematic illustration of a SAN including a SAN management system according to an embodiment of the invention;

FIG. 2 is a flow chart illustrating a test process performed by the management system of FIG. 1; and

FIG. 3 is a flow chart illustrating fault processing by the management system of FIG. 1

### DETAILED DESCRIPTION OF A PREFERRED EMBODIMENT OF THE INVENTION

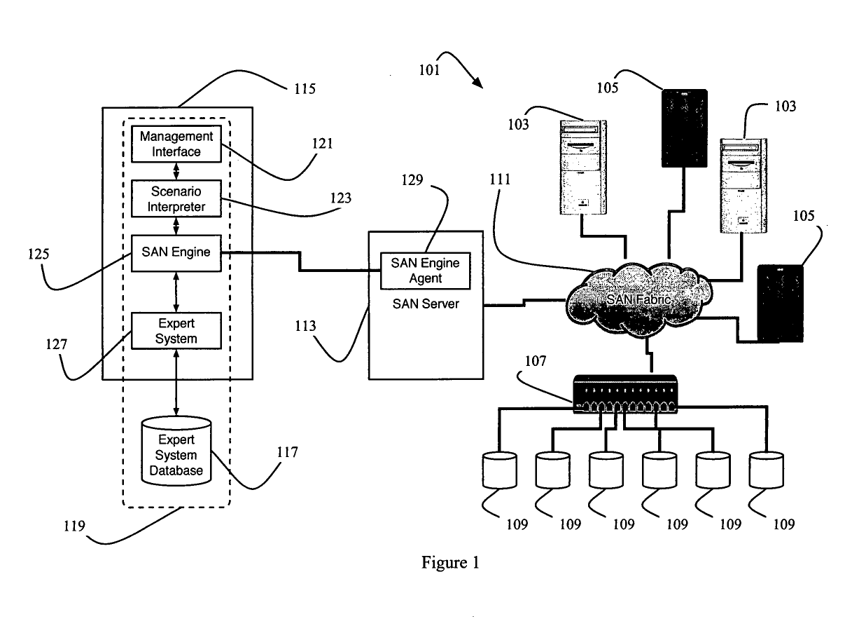

FIG. 1 shows a SAN 101 comprising server computers 103, storage devices 105, a RAID (Redundant Array of Independent Disks) disk controller 107 and disk drives 109. The RAID disk controller and the disk drives together form a RAID disk array. These SAN elements are interconnected by the SAN Fabric 111. A further SAN server computer 113 is connected to the SAN via a Host Bus Adaptor (HBA) (not shown) and the Fabric 111 and to a client computer 115 which in turn is connected to a database 117.

The client computer 115 is installed with a SAN management system 119 which comprises a management interface 121, a scenario interpreter 123, a SAN engine 125 and an expert system 127. The expert system 127 uses the database 117 to store the data used for its operation. The SAN engine includes a separate agent module 129 which runs on the SAN server 113.

The SAN management system 119 is arranged to provide a test framework for testing SAN hardware and software components. The system 119 is designed using client server architecture in which the management interface 121, the scenario interpreter 123 and the SAN engine 125 reside on the client machine running Windows™ operating system. A SAN engine agent 129 associated with the SAN engine resides on the host or server computer 113, which is connected to the SAN 101.

Management Interface

The management interface 121 provides controls and displays for the execution of tests carried out on the SAN. The management interface provides a collection of generic user interfaces wherein user can add customised test scenarios for testing the SAN. The interface comprises the following displays and controls:
Controls for selecting and filtering test cases to create environment specific test;
Controls for collecting performance data, input/output (IO) statistics and system performance statistics;
Controls for gathering SAN component specific information such as Fibre Channel (FC), Host Bus Adaptors (HBAs), FC switches, disk array controllers and disk array Logical Unit Numbers (LUNs);
Displays of the state of a current test scenario being executed and system/IO performance, trace messages for path coverage, IO error messages and assertion errors in test scripts; and
Controls for logging of test result data.

The management interface 121, receives messages from each part of the system 119 and distributes the messages to the appropriate user interface controls. The management interface 121 communicates with the SAN engine 125 and receives status and trace messages of a test scenario execution. The management interface 121 interacts with the expert system 127 to obtain test scenarios/cases suitable for a given SAN configuration which is under test. The management interface 121 is also equipped with a test scenario editor to enable a user to create and modify test procedures.

SAN Engine

The SAN engine 125 controls and regulates the SAN components and is responsible for executing actual SAN operations and communicating test status and trace messages to the management layer. The SAN engine is responsible for initiating the SAN operations in response to requests from the interpreter 123. The SAN operation requests are translated as a function call to the SAN engine which builds a message packet containing appropriate commands which is then sent to the SAN engine agent 129. During the course of execution of a test scenario, the SAN engine receives sequences of trace messages from the SAN and status messages from the SAN agent.

The SAN engine agent 129 is responsible for the actual execution of the SAN operations. The agent receives one or more commands and executes one command at a time. After completing a specific SAN operation the agent sends a message to the SAN engine which contains the status and/or trace information generated by the test scenario. The message structure is as follows:

| | | | | | | |
|---|---|---|---|---|---|---|
| STX | Pkt Size | MT | MC | Msg Size | Message | ETX |

In which:
STX defines the start of message header;
Pkt Size defines the size of the entire packet;
MT defines the message type (Command, Trace, Status, Etc.);
MC defines the message code (Execution type);
Msg Size defines the size of single message packet;
Message defines the actual message; and
ETX defines the end of message packet.

The SAN engine agent 129 is also responsible for collecting information from the SAN which is compiled into a data set called a device map. As soon as the agent begins processing it issues commands over SCSI (Small Computer Serial Interface), Fibre Channel (FC) or TCP/IP paths to the storage devices 105, 107, 109 and determines identification and operational data for the devices. If a switch is connected between the SAN server 113 and any of the storage devices then the agent also retrieves the relevant port information to define the connection to the given storage device. The device map information is communicated to the management interface. The agent continues to scan the SAN configuration at regular intervals and updates the device map when necessary. The device map is used by the user to create a test workspace in which to configure test procedures to simulate a SAN operational scenario.

Test Scenario Interpreter

The scenario interpreter 123 controls the flow of test scenario execution by the SAN engine. A test scenario consists of one or more test cases and each test case consists of one or more test procedures. The logical flow of test procedures is defined by a scripting language which is a simplified version of the C programming language and so is procedure orientated. The language supports loops and conditional statements along with the following primitive data types:
int—integer data type;
char—character data type;
arrays—integer and character arrays; and
string—character string.

The script language exposes a set of predefined SAN primitive operations. The scenario interpreter parses the operations and interprets them as function calls to the SAN Engine for executing actual SAN operations. Following are a selection of the SAN operations:
DisableHBA(WWN info)—Disable the miniport driver of HBA.
EnableHBA(WWN info)—Enable the miniport driver of HBA.
ConnectSwitch (Ipaddr, Port)—Establish a telnet session to a fabric switch using IP address.
DisconnectSwitch (IPaddr, Port)—Disconnect the defined telnet session from the fabric switch.
DisablePort (Port Number)—Disable a specific switch port.
DisablePort (PortNum1, PortNum2, . . . )—Disable the specified range of switch ports.
GenerateIO(IOBlockSize,Duration,ReadPercent,RandomPercent,LUNinfo)—Generate IO on devices.
GetPortErr (Port Number)—Fetch the error message from the switch.
GetPortStatus (Port Number)—Fetch the status of the switch port.
SendSwitch(Switch Command)—Send an actual switch command via telnet session.
EnablePath (PortBusTargetLUN)—Enable a path from HBA to array based on PBTL.
DisablePath (PortBusTargetLUN)—Disable a path from HBA to array based on PBTL.
SleepTimer (nSecs)—Pause the test execution for a specified number of seconds.
System (exec file)—Execute any system related executable/batch file.

The scenario interpreter can operate in two modes, a normal execution mode and a system level mode. In the normal execution mode, all operations defined in a test scenario are executed including SAN primitive operations. In the system level mode only the system/host specific commands are executed.

Expert System

The expert system 127 governs the testing process and evaluates and/or qualifies the SAN configuration. The expert system is also responsible for automatic selection of test scenarios/cases for a given SAN configuration and for localisation of faults in case of errors/failures during testing. The expert system has rule sets for the conditional execution of a set of test cases/scenarios. The expert system operates in two modes, an initial learning mode and an operational mode. In the learning mode, the expert system database 119 is populated with a set of basic knowledge which includes base SAN configuration models, information on SAN components, known problems with particular configurations and test scenarios for the base SAN configurations and for the specific SAN components. The following configuration information is initially populated into the database:
Fabric Attach—a simple Host-1 FC Switch-Array configuration
Direct Attach—a Host-Array direct attach configuration

The SAN component information which is initially populated into the expert system database is as follows:
Host properties such as operating system, version, storage, software components and architecture;
Fibre channel switch properties—switch vendor information, speed, firmware version, topological information, zone/path information and operating limits;
Host FC HBA properties such as vendor, version, speed and operating limits;
Configuration such as Direct Attach and Fabric Attach;
Disk array properties such as vendor, version, speed, hardware ID and operating limits;
Disk array controller properties such as controller type, controller properties and controller specific operating limits; and
Disk array LUNs, capacity and count.

In operational mode, the expert system automatically tests a SAN configuration. Firstly, the expert system searches the database 117 for a stored configuration that matches that of the supplied configuration to be tested. Once the system finds the match for the configuration, the appropriate rule set is executed on the SAN in the form of a set of tests. The system executes the rule set and compares the results with the database. If a problem is identified in the SAN this is reported to the user via the management interface. Any newly identified faults are categorised and stored against the appropriate configuration and scenario in the database for further evaluation. If the expert system is not able to find the exact match of the configuration in the database then it will choose the closest match. In this partial match case only the applicable elements of the rule set are used for testing. After test execution, the expert system stores the partially matched configuration as a new configuration.

In summary, after a testing procedure, the following information is updated in the database:
SAN configuration on which the testing have been initiated;
Test scenarios/cases used for the testing;
Error logs such as IO errors or errors reported by components; and
Fault data to enable the tracing of faults in later processing.

When a specific test has failed, the expert system probes the SAN configuration to attempt to localise the fault to a component or a region of the SAN. A region is a set of components, such as host or server computer or an FC switch. The fault localisation process searches the database for logs of similar errors for a given SAN configuration along with associated causes. If a similar error is found then any localised tests associated with the fault are obtained from the database and executed on the SAN appropriately. The results of the fault probing are reported to the user via the management interface.

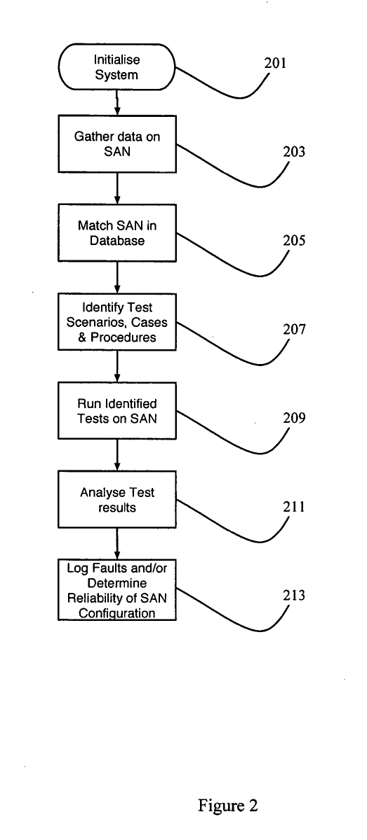

The testing process performed by the expert system will now be described with reference to the flowchart of FIG. 2 in which at step 201, the system is initialised. As noted above, initialisation includes populating the database with basic SAN configurations, test scenarios, procedures and cases, known faults and SAN element performance limits and data.

Processing then moves to step 203 where the SAN engine interrogates the SAN to be tested and collects data on its topology and the elements that it comprises. Processing then moves to step 205 where the database is searched for the nearest matching model to the SAN being tested. Processing then moves to step 207 where the test scenario, procedures and cases for the nearest match in SAN model are selected from the database and processing moves to step 209 where the tests are run on the SAN. At step 211 the results of the testing are analysed and presented to the user via the management interface and processing moves to step 213. At step 213, any faults detected during the testing are logged along with the SAN configuration in the database and a reliability measure calculated for the SAN. The reliability measure is based on the degree of matching between the actual SAN and the model SAN used for testing and also the age of the test scenarios used. The reliability measure is also provided to the user via the management interface. Once the user has the results of the tests and logs of any faults, the SAN can be modified if necessary and retested. If faults have been discovered then the fault probing system can be initiated in order to further identify the SAN region or element causing the fault.

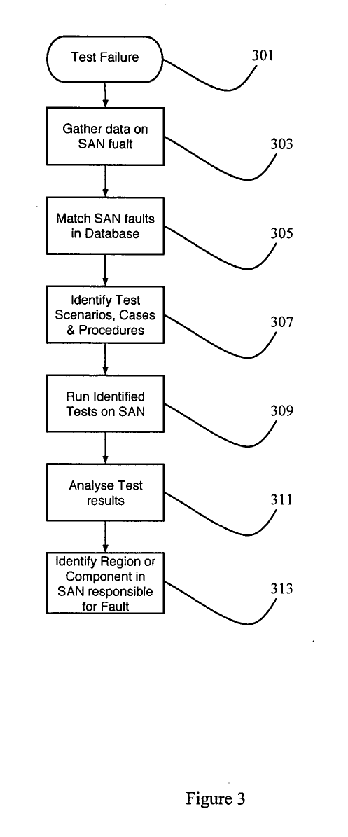

The fault probing process performed by the expert system will now be described with reference to the flowchart of FIG. 3 in which at step 301, the process is initiated by a SAN test failure being identified. Processing then moves to step 303 in which the database is searched for probing procedures associated with the same type of fault that has occurred. Once a match has been found, then at step 305 the associated test procedures are retrieved from the database at step 307. The test procedures are designed to diagnose the location of the faults to a region or element of the SAN. At step 309 the test procedures are executed on the SAN by the SAN engine. Once the test are complete then at step 311 the results of the tests are analysed and at step 313 the test results are used to identify the region of component of the SAN which is responsible for the faults and these finding are presented to the user via the management interface. The user can then make suitable changes to the SAN configuration or that of one or more of its elements to remove the faults. The SAN can then be retested against its previous test scenarios which have been stored in the database.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via various transmission or storage means such as computer network, floppy disc, CD-ROM or magnetic tape so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method of managing a data storage network, the method comprising the steps of:
a) storing a model configuration of a data storage network and an associated test scenario for said model data storage network;
b) collecting data representing an actual data storage network configuration;
c) comparing said data representing the actual data storage network to said model configuration of a data storage network; and
d) if said collected data corresponds to said stored model configuration then applying said associated test scenario to said actual data storage network.

2. A method according to claim 1 in which said data storage network is a Storage Area Network (SAN).

3. A method according to claim 1 in which if in step d) said collected data only partially corresponds to said model configuration then only applying the elements of said test scenario to said actual data storage network where said partial correspondence exists.

4. A method according to claim 1 further comprising the step of:
e) storing a model of said actual data storage network and subsequently comparing data representing a further actual data storage network and said stored models and selecting one of said models which corresponds most closely to said further actual data storage network.

5. A method according to claim 1 in which said model comprises topological data and component characteristics.

6. A method according to claim 1 in which in step a) a set of fault finding procedures are stored and if a fault indicated by said test scenario corresponds to one of said fault finding procedures, said procedure is applied to the actual data storage network to locate said fault.

7. A method according to claim 6 in which said fault finding procedures are arranged to locate a fault within a region of said actual data storage network.

8. A method according to claim 6 in which said fault finding procedures are arranged to locate a fault within an element of said actual data storage network.

9. Apparatus for managing a data storage network comprising:
a database for storing a model configuration of a data storage network and an associated test scenario for said model data storage network;
an engine for collecting data representing an actual data storage network configuration; and
an expert system for comparing said data representing said actual data storage network to said model configuration of a data storage network, wherein if said collected data corresponds to said stored model configuration then said engine is further operable to apply said associated test scenario to said actual data storage network.

10. Apparatus according to claim 9 in which said data storage network is a Storage Area Network (SAN).

11. Apparatus according to claim 9 in which said expert system is operable, if said collected data only partially corresponds to said model configuration, to only applying elements of said test scenario to said actual data storage network where said partial correspondence exists.

12. Apparatus according to claim 9 in which the model of said actual data storage network is stored and subsequently used for comparing data representing a further actual data storage network and said stored models and selecting one of said models which corresponds most closely to said further actual data storage network.

13. Apparatus according to claim 9 in which said model comprises topological data and component characteristics.

14. Apparatus according to claim 9 in which a set of fault finding procedures are stored in said database and if a fault indicated by said test scenario corresponds to one of said fault finding procedures, said procedure is applied to said actual data storage network to locate said fault.

15. Apparatus according to claim 14 in which said fault finding procedures are arranged to locate a fault within a region of said actual data storage network.

16. Apparatus according to claim 14 in which said fault finding procedures are arranged to locate a fault within an element of said actual data storage network.

17. A computer program or group of computer programs arranged to enable a computer or group of computer programs to carry out the method of claim 1.

18. A computer program or group of computer programs arranged to enable a computer or group of computer programs to provide the apparatus of claim 9.

19. Apparatus for automated selection of test scenarios for a Storage Area Network (SAN), the apparatus comprising:
an expert system database for storing a model configuration of a SAN and an associated test scenario for said SAN;
a SAN engine for collecting data representing an actual SAN configuration;
an expert system for comparing said data representing the actual SAN to said model configuration of a SAN; and
a scenario interpreter operable, if said collected data corresponds to said stored model configuration, to apply said associated test scenario to said actual SAN.
